(19) United States
(12) Patent Application Publication
(10) Pub. No.: US 2018/0058372 A1
(43) Pub. Date: Mar. 1, 2018

(54) AIRCRAFT THRUST REVERSER SYSTEM WITH ADDITIONAL REVERSE THRUST GROUNDING PATH

(71) Applicant: HONEYWELL INTERNATIONAL INC., Morris Plains, NJ (US)

(72) Inventors: Donald Jeffrey Christensen, Phoenix, AZ (US); Kevin K. Chakkera, Chandler, AZ (US); Daniel C. Birchak, Gilbert, AZ (US); James Wawrzynek, Phoenix, AZ (US)

(73) Assignee: HONEYWELL INTERNATIONAL INC., Morris Plains, NJ (US)

(21) Appl. No.: 15/358,437

(22) Filed: Nov. 22, 2016

Related U.S. Application Data
(60) Provisional application No. 62/378,962, filed on Aug. 24, 2016.

(51) Int. Cl. F02K 1/62; F02K 1/76

(52) U.S. Cl. CPC F02K 1/625; F02K 1/763

(57) ABSTRACT

A thrust reverser system for a gas turbine engine includes a support structure, a transcowl, an actuator, and a retractable cable. The support structure is configured to be mounted to the turbine engine. The transcowl is mounted on the support structure and is axially translatable, relative to the support structure, between a stowed position and a deployed position. The actuator is configured to supply an actuation force to the transcowl to thereby move the transcowl between the stowed and deployed positions. The retractable cable is coupled to the transcowl and the support structure, and is configured to react reverse thrust loads on the transcowl at least when the transcowl is in the deployed position, to thereby at least reduce thrust loading on the actuator.

### CROSS-REFERENCE TO RELATED APPLICATION

This application claims the benefit of U.S. Provisional Application No. 62/378,962, filed Aug. 24, 2016.

### TECHNICAL FIELD

The present invention generally relates to aircraft thrust reversers, and more particularly relates to an aircraft thrust reverser that includes an additional reverse thrust grounding path.

### BACKGROUND

When turbine-powered aircraft land, the wheel brakes and the imposed aerodynamic drag loads (e.g., flaps, spoilers, etc.) of the aircraft may not be sufficient to achieve the desired stopping distance. Thus, the engines on most turbine-powered aircraft include thrust reversers. Thrust reversers enhance the stopping power of the aircraft by redirecting the engine exhaust airflow in order to generate reverse thrust. When stowed, the thrust reverser typically forms a portion of the engine nacelle and forward thrust nozzle. When deployed, the thrust reverser typically redirects at least a portion of the airflow (from the fan and/or engine exhaust) forward and radially outward, to help decelerate the aircraft.

Various thrust reverser designs are commonly known, and the particular design utilized depends, at least in part, on the engine manufacturer, the engine configuration, and the propulsion technology being used. Thrust reverser designs used most prominently with turbofan engines fall into two general categories: (1) fan flow thrust reversers, and (2) mixed flow thrust reversers. Fan flow thrust reversers affect only the bypass airflow discharged from the engine fan. Whereas, mixed flow thrust reversers affect both the fan airflow and the airflow discharged from the engine core (core airflow).

Fan flow thrust reversers are typically used on relatively high-bypass ratio turbofan engines. Fan flow thrust reversers include so-called “Cascade-type” or “Translating Cowl-type” thrust reversers. Fan flow thrust reversers are generally positioned circumferentially around the engine core aft of the engine fan and, when deployed, redirect fan bypass airflow through a plurality of cascade vanes disposed within an aperture of a reverse flow path. Typically, fan flow thrust reverser designs include one or more translating sleeves or cowls (“transcowls”) that, when deployed, open an aperture, expose cascade vanes, and create a reverse flow path. Fan flow reversers may also include so-called pivot doors or blocker doors which, when deployed, rotate to block the forward thrust flow path.

In contrast, mixed flow thrust reversers are typically used with relatively low-bypass ratio turbofan engines. Mixed flow thrust reversers typically include so-called “Target-type,” “Bucket-type,” and “Clamshell Door-type” thrust reversers. These types of thrust reversers typically use two or more pivoting doors that rotate, simultaneously opening a reverse flow path through an aperture and blocking the forward thrust flow path. However, a transcowl type thrust reverser could also be configured for use in a mixed flow application. Regardless of type, mixed flow thrust reversers are necessarily located aft or downstream of the engine fan and core, and often form the aft part of the engine nacelle.

Transcowl type thrust reversers transition from the forward thrust state to the reverse thrust state by translating the transcowl aft so as to open a reverse thrust aperture, and simultaneously rotating a set of doors so as to obstruct the forward thrust nozzle. This coordinated motion between the transcowl and the doors is typically achieved by the use of a linkage arrangement, which connects the doors to the transcowl so that translational motion of the transcowl causes rotational motion of the doors. The linkage may reside in the fan air stream during flight, which causes undesirable performance losses. However, removing this linkage eliminates one of the load paths used to react aerodynamic loads, which results in higher loads in the actuators, which in turn drives an increase in actuator size and weight.

Hence there is a need for a thrust reverser actuation system configuration that will simultaneously provide a light-weight solution and a clean airstream, while continuing to provide load paths used to react aerodynamic loads. The present invention addresses at least this need.

### BRIEF SUMMARY

This summary is provided to describe select concepts in a simplified form that are further described in the Detailed Description. This summary is not intended to identify key or essential features of the claimed subject matter, nor is it intended to be used as an aid in determining the scope of the claimed subject matter.

In one embodiment, a thrust reverser system for a gas turbine engine includes a support structure, a transcowl, an actuator, and a retractable cable. The support structure is configured to be mounted to the turbine engine. The transcowl is mounted on the support structure and is axially translatable, relative to the support structure, between a stowed position and a deployed position. The actuator is configured to supply an actuation force to the transcowl to thereby move the transcowl between the stowed and deployed positions. The retractable cable is coupled to the transcowl and the support structure, and is configured to react reverse thrust loads on the transcowl at least when the transcowl is in the deployed position, to thereby at least reduce thrust loading on the actuator.

In another embodiment, a thrust reverser system for a gas turbine engine includes a support structure, a support structure, an transcowl, an actuator, a rotatable drum, and a retractable cable. The support structure is configured to be mounted to the turbine engine. The transcowl is mounted on the support structure and is axially translatable, relative to the support structure, between a stowed position and a deployed position. The actuator is configured to supply an actuation force to the transcowl to thereby move the transcowl between the stowed and deployed positions. The rotatable drum is coupled to the support structure. The retractable cable is coupled to the transcowl and is partially wound on the rotatable drum, whereby the retractable cable at least partially unwinds from the rotatable drum when the transcowl moves from the stowed position to the deployed position, and is wound back onto the rotatable drum when the transcowl moves from the deployed position to the stowed position, the retractable cable configured to react reverse thrust loads on the transcowl at least when the transcowl is in the deployed position, to thereby at least reduce thrust loading on the actuator.

In yet another embodiment, a thrust reverser system for a gas turbine engine includes a support structure, a plurality of transcowls, a plurality of actuators, and a plurality of retractable cables. The support structure is configured to be mounted to the turbine engine. The transcowls are mounted on the support structure, and each transcowl axially translatable, relative to the support structure, between a stowed position and a deployed position. Each actuator is coupled to, and is configured to supply an actuation force to, one of the transcowls to thereby move the transcowls between the stowed and deployed positions. Each retractable cable is coupled to the support structure and one of the transcowls, and each retractable cable is configured to react reverse thrust loads on the transcowl to which it is coupled at least when the transcowl to which it is coupled is in the deployed position, to thereby at least reduce thrust loading on each actuator that is coupled to the same transcowl.

Furthermore, other desirable features and characteristics of the aircraft thrust reverser system will become apparent from the subsequent detailed description and the appended claims, taken in conjunction with the accompanying drawings and the preceding background.

### BRIEF DESCRIPTION OF THE DRAWINGS

The present invention will hereinafter be described in conjunction with the following drawing figures, wherein like numerals denote like elements, and wherein:

FIGS. 1 and 2 depict a turbofan engine equipped with a mixed flow thrust reverser system, and with the thrust reverser system in a stowed position and deployed position, respectively;

FIGS. 3 and 4 depict a turbofan engine equipped with a fan flow thrust reverser system, and with the thrust reverser system in a stowed position and deployed position, respectively; and

FIG. 5 depicts a functional schematic representation of an actuation control system that may be used in the embodiments of FIGS. 1-4.

### DETAILED DESCRIPTION

The following detailed description is merely exemplary in nature and is not intended to limit the invention or the application and uses of the invention. As used herein, the word “exemplary” means “serving as an example, instance, or illustration.” Thus, any embodiment described herein as “exemplary” is not necessarily to be construed as preferred or advantageous over other embodiments. All of the embodiments described herein are exemplary embodiments provided to enable persons skilled in the art to make or use the invention and not to limit the scope of the invention which is defined by the claims. Furthermore, there is no intention to be bound by any expressed or implied theory presented in the preceding technical field, background, brief summary, or the following detailed description.

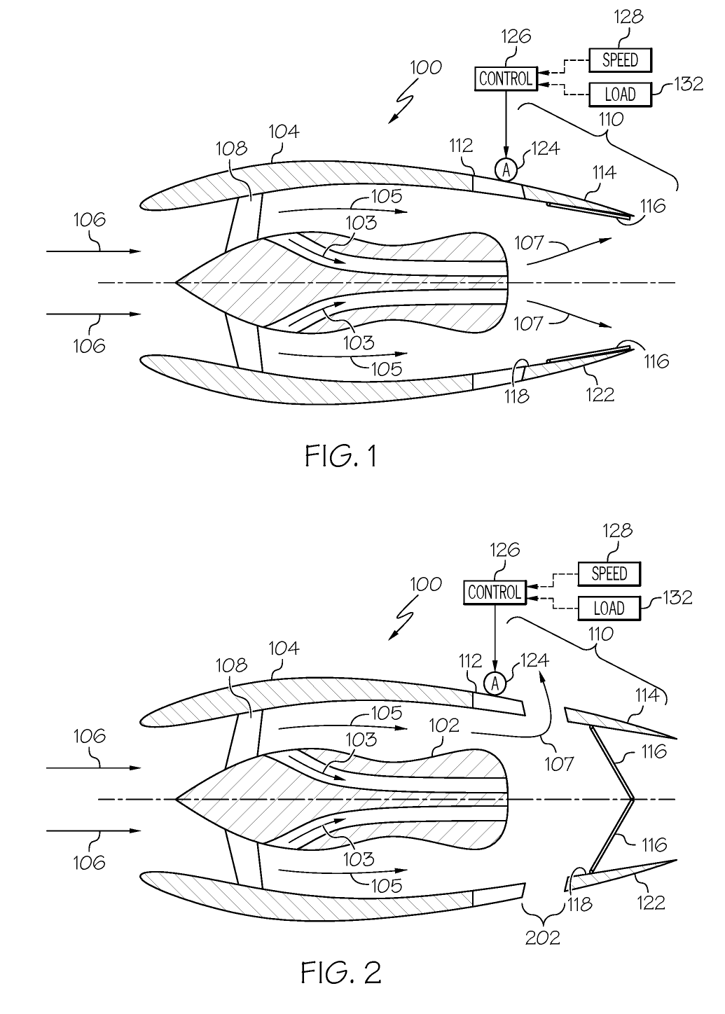

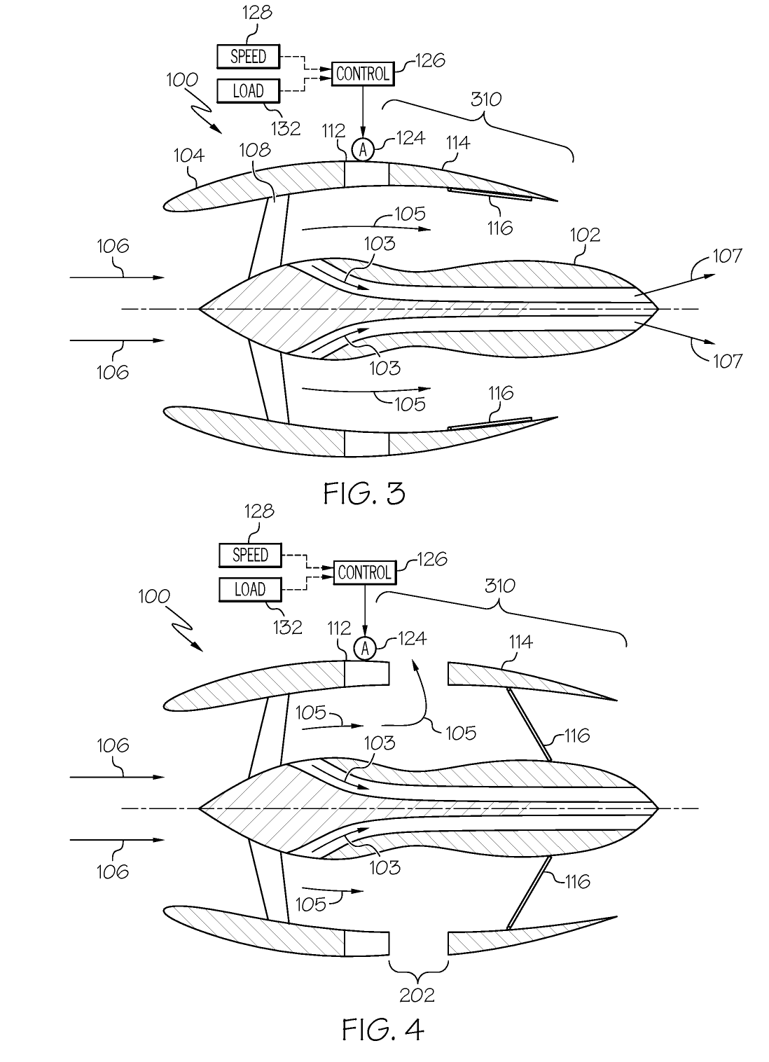

A turbofan engine is a component of an aircraft's propulsion system that typically generates thrust by means of an accelerating mass of gas. Simplified cross section views of a traditional aircraft turbofan engine 100 are depicted in FIGS. 1-4. In particular, FIGS. 1 and 2 depict the engine 100 equipped with a mixed flow thrust reverser system, and with the thrust reverser system in a stowed position and deployed position, respectively, and FIGS. 3 and 4 depict the engine 100 equipped with a fan flow thrust reverser system, and with the thrust reverser system in a stowed position and deployed position, respectively.

Referring first to FIGS. 1 and 2, the turbofan engine 100 includes a gas turbine engine 102 that is encased within an aerodynamically smooth outer covering, generally referred to as the nacelle 104. Ambient air 106 is drawn into the nacelle 104 via a rotationally mounted fan 108 to thereby supply engine airflow. A portion of the engine airflow is drawn into the gas turbine engine 102, where it is pressurized, and mixed with fuel and ignited, to generate hot gasses known as core flow 103. The remainder of engine airflow bypasses the gas turbine engine 102 and is known as fan flow 105. The core flow 103 and the fan flow 105 mix downstream of the gas turbine engine 102 to become the engine exhaust flow 107, which is discharged from the turbofan engine 100 to generate forward thrust.

The nacelle 104 comprises a mixed flow thrust reverser system 110. The thrust reverser system 110 includes a support structure 112, an annular translatable cowl, or transcowl 114, and one or more doors 116 (two in the depicted embodiment). The transcowl 114 is mounted on the support structure 112 and has an inner surface 118 and an outer surface 122. The transcowl 114 is axially translatable, relative to the support structure 112, between a stowed position, which is the position depicted in FIG. 1, and a deployed position, which is the position depicted in FIG. 2. In the stowed position, the transcowl 114 is disposed adjacent the support structure 112. In the deployed position, the transcowl 114 is displaced from the support structure 112 by a second distance to form a reverse thrust aperture 202 (see FIG. 2).

Each of the one or more doors 116 is rotatable between a first position, which is the position depicted in FIG. 1, and a second position, which is the position depicted in FIG. 2. More specifically, each door 116 is rotatable between the first position and the second position, when the transcowl 114 translates between the stowed position and the deployed position, respectively. As is generally known, each door 116 is configured, when it is in the second position, to redirect at least a portion of the engine airflow through the reverse thrust aperture 202 to thereby generate reverse thrust. In particular, at least a portion of the engine exhaust flow 107 (e.g., mixed core flow 103 and fan flow 105) is redirected through the reverse thrust aperture 202.

Referring now to FIGS. 3 and 4, the turbofan engine 100 equipped with a fan flow thrust reverser system 310 will be briefly described. Before doing so, however, it is noted that like reference numerals in FIGS. 1-4 refer to like parts, and that descriptions of the like parts of the depicted turbofan engines 100 will not be repeated. The notable difference between the turbofan engine 100 depicted in FIGS. 3 and 4 is that the fan flow thrust reverser system 310 is disposed further upstream than that of the mixed flow thrust reverser system 110 depicted in FIGS. 1 and 2.

As with the mixed flow thrust reverser system 110, the depicted fan flow thrust reverser system 310 includes the support structure 112, the transcowl 114, and the one or more doors 116 (again, two in the depicted embodiment). Moreover, each door 116 is rotatable between a first position, which is the position depicted in FIG. 3, and a second position, which is the position depicted in FIG. 4. Similarly, each door 116 is rotatable between the first position and the second position, when the transcowl 114 translates between the stowed position and the deployed position, respectively. As is generally known, each door 116 is configured, when it is in the second position, to redirect at least a portion of the engine airflow through the reverse thrust aperture 202 to thereby generate reverse thrust. In this case, however, only fan bypass flow 105 is redirected through the reverse thrust aperture 202.

As FIGS. 1-4 also depict, the thrust reverser systems 110, 310 additionally include a plurality of actuators. Each actuator 124 is coupled to the support structure 112 and a transcowl 114, and is configured to supply an actuation force to the transcowl 114. More specifically, each actuator 124 is responsive to commands supplied from a control 126 to supply an actuation force to the transcowl 114, to thereby move the transcowl 114 between the stowed position and the deployed position. It will be appreciated that the main actuators 124 may be implemented using any one of numerous types of actuators. In the depicted embodiment, each is implemented using linear screw-type actuator that includes an alternate reverse thrust load path.

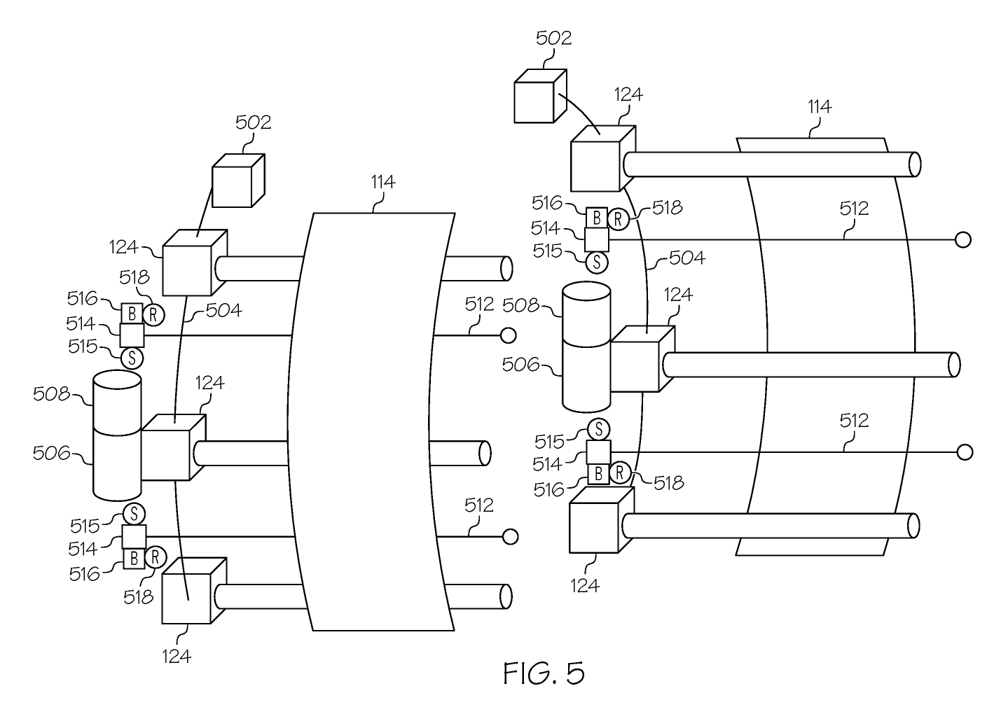

As shown more clearly in FIG. 5, the actuators 124 are individually coupled to the transcowls 114. In the depicted embodiment, half of the actuators 124 are coupled to one of the transcowls 114, and the other half are coupled to the other transcowl 114. As FIG. 5 additionally depicts, some of the actuators 124 may include locks 502. In addition, the transcowls 114 also may each include locks (not depicted). It is noted that the actuators 124 may be any one of numerous actuator designs presently known in the art or hereafter designed. However, in this embodiment the actuators 124 are ballscrew actuators. It is additionally noted that the number and arrangement of actuators 124 is not limited to what is depicted in FIG. 5, but could include other numbers of actuators 124 as well.

The actuators 124 associated with each transcowl are interconnected via a plurality of drive mechanisms 504, each of which, in the particular depicted embodiment, comprises a flexible shaft. The flexible shafts 504 ensure that the actuators 124, and thus all points of each transcowl 114, move in a substantially synchronized manner. Other drive or synchronization mechanisms that may be used include electrical synchronization or open loop synchronization, or any other mechanism or design that transfers power between the actuators 124.

A drive unit 506, such as a motor, is coupled to one of the actuators 124 associated with each transcowl 114. Although the depicted embodiment uses two drive units, one associated with each of the transcowls 114, in other embodiments only a single drive unit with dual outputs may be used. It will additionally be appreciated that the systems 110, 310 may be implemented with more than the number of depicted drive units 506, as required to meet the specific design requirements of a particular thrust reverser system. Each drive unit 506 may be either an electric (including any one of the various DC or AC motor designs known in the art), a hydraulic, or a pneumatic motor. Moreover, as FIG. 5 depicts, the drive units 506 may additionally include a locking mechanism 508.

The depicted systems 110, 310 additionally include one or more retractable cables 512. In the depicted embodiment, there are two retractable cables 512 associated with each transcowl 114. It will be appreciated, however, that more or less than this number of retractable cables 512 could be associated with each transcowl 114. No matter the specific number of retractable cables 512, each one is coupled to one of the transcowls 114 and to the support structure 112 (not illustrated in FIG. 5), and each retractable cable 512 is configured to react reverse thrust loads on the transcowl 114 at least when the transcowl 114 is in the deployed position. As a result, and depending on the specific configuration, thrust loading on the actuators 124 is either reduced or fully bypassed at least when the transcowl 114 is in the deployed position. To implement this functionality, each cable 512 is coupled to, and is retractably wound on, a rotatable drum structure 514. The rotatable drum 514 is preferably spring loaded, via a spring 515 that is coupled to the drum 514, to automatically retract the cable 512 back onto the drum 514 when the transcowls 114 are being stowed. It will be appreciated that the retractable cables 512 may be implemented using various types of cables, but in a particular preferred embodiment are implemented using high-strength synthetic cable materials. Some examples of high-strength synthetic cable include cable made with high-modulus polyethylene (HMPE) fiber, such as Honeywell Spectra® fiber, and cable made with a liquid crystal polymer, such as Vectran™.

In some embodiments, one or more of the drums 514 could be configured to exhibit drag during deploy. For example, one or more of the drums 514 may include a brake 516, such as a carbon disc brake, that is engaged during deploy, and a simple ratchet 518 that disengages the brake 516 during stow. This configuration allows even further reduction in the actuator size because part of the deploy loads would also be carried by the retractable cables 512. In other embodiments, the brake 516 could be electrically, hydraulically, or pneumatically controlled to engage and disengage. For example, the braking torque could be controlled based on speed and/or load. In such embodiments, and as FIGS. 1-4 further depict, the system 100 may additionally include one or more speed sensors 128 (only one depicted) and/or one or more load sensors 132 (only one depicted). The speed sensor(s) 128 may be variously disposed to sense the speed of various system components, such as, for example, one or more of the drums 514, one or more of the actuators 124, one or more of the motors 506, and/or one or more of the transcowls 114. In one particular embodiment, a speed sensor 128 that is used to control actuator speed may also be used to provide speed feedback for braking torque control. The load sensor(s) 132 may also be variously disposed to sense load. In one particular embodiment, the load sensor(s) 132 is disposed to sense load at one or more of the drums 514.

In this document, relational terms such as first and second, and the like may be used solely to distinguish one entity or action from another entity or action without necessarily requiring or implying any actual such relationship or order between such entities or actions. Numerical ordinals such as “first,” “second,” “third,” etc. simply denote different singles of a plurality and do not imply any order or sequence unless specifically defined by the claim language. The sequence of the text in any of the claims does not imply that process steps must be performed in a temporal or logical order according to such sequence unless it is specifically defined by the language of the claim. The process steps may be interchanged in any order without departing from the scope of the invention as long as such an interchange does not contradict the claim language and is not logically nonsensical.

Furthermore, depending on the context, words such as “connect” or “coupled to” used in describing a relationship between different elements do not imply that a direct physical connection must be made between these elements. For example, two elements may be connected to each other physically, electronically, logically, or in any other manner, through one or more additional elements.

While at least one exemplary embodiment has been presented in the foregoing detailed description of the invention, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing an exemplary embodiment of the invention. It being understood that various changes may be made in the function and arrangement of elements described in an exemplary embodiment without departing from the scope of the invention as set forth in the appended claims.

What is claimed is:

1. A thrust reverser system for a gas turbine engine, comprising:
a support structure configured to be mounted to the turbine engine;
a transcowl mounted on the support structure and axially translatable, relative to the support structure, between a stowed position and a deployed position;
an actuator configured to supply an actuation force to the transcowl to thereby move the transcowl between the stowed and deployed positions; and
a retractable cable coupled to the transcowl and the support structure, the retractable cable configured to react reverse thrust loads on the transcowl at least when the transcowl is in the deployed position, to thereby at least reduce thrust loading on the actuator.

2. The thrust reverser system of claim 1, wherein the retractable cable fully bypasses the thrust loading on the actuator.

3. The thrust reverser system of claim 1, further comprising:
a rotatable drum coupled to the support structure, the rotatable drum having at least a portion of the retractable cable retractably wound thereon.

4. The thrust reverser system of claim 3, further comprising:
a spring coupled to the rotatable drum and configured to supply a torque to the rotatable drum to thereby automatically retract the retractable cable back onto the rotatable drum when the transcowl translates to the stowed position.

5. The thrust reverser system of claim 3, wherein the retractable cable at least partially unwinds from the rotatable drum when the transcowl moves from the stowed position to the deployed position, and is wound back onto the rotatable drum when the transcowl moves from the deployed position to the stowed position.

6. The thrust reverser system of claim 5, wherein the retractable drum is configured to exhibit drag when the retractable cable is unwinding therefrom.

7. The thrust reverser system of claim 6, further comprising:
a brake coupled to the rotatable drum and configured to at least selectively supply a braking torque to the rotatable drum, whereby the rotatable drum exhibits drag when the retractable cable is unwinding therefrom.

8. The thrust reverser system of claim 7, wherein the brake comprises:
a disc brake that is engaged when the retractable cable is unwinding from the rotatable drum; and
a ratchet that disengages the disc brake when the transcowl moves from the deployed position to the stowed position.

9. A thrust reverser system for a gas turbine engine, comprising:
a support structure configured to be mounted to the turbine engine;
a transcowl mounted on the support structure and axially translatable, relative to the support structure, between a stowed position and a deployed position;
an actuator configured to supply an actuation force to the transcowl to thereby move the transcowl between the stowed and deployed positions;
a rotatable drum coupled to the support structure; and
a retractable cable coupled to the transcowl and partially wound on the rotatable drum, whereby the retractable cable at least partially unwinds from the rotatable drum when the transcowl moves from the stowed position to the deployed position, and is wound back onto the rotatable drum when the transcowl moves from the deployed position to the stowed position, the retractable cable configured to react reverse thrust loads on the transcowl at least when the transcowl is in the deployed position, to thereby at least reduce thrust loading on the actuator.

10. The thrust reverser system of claim 9, wherein the retractable cable fully bypasses the thrust loading on the actuator.

11. The thrust reverser system of claim 9, further comprising:
a spring coupled to the rotatable drum and configured to supply a torque to the rotatable drum to thereby automatically retract the retractable cable back onto the rotatable drum when the transcowl translates to the stowed position.

12. The thrust reverser system of claim 9, further comprising:
a brake coupled to the rotatable drum and configured to at least selectively supply a braking torque to the rotatable drum, whereby the rotatable drum exhibits drag when the retractable cable is unwinding therefrom.

13. A thrust reverser system for a gas turbine engine, comprising:
a support structure configured to be mounted to the turbine engine;
a plurality of transcowls mounted on the support structure, each transcowl axially translatable, relative to the support structure, between a stowed position and a deployed position;
a plurality of actuators, each actuator coupled to, and configured to supply an actuation force to, one of the transcowls to thereby move the transcowls between the stowed and deployed positions; and
a plurality of retractable cables, each retractable cable coupled to the support structure and one of the transcowls, each retractable cable configured to react reverse thrust loads on the transcowl to which it is coupled at least when the transcowl to which it is coupled is in the deployed position, to thereby at least reduce thrust loading on each actuator that is coupled to the same transcowl.

14. The thrust reverser system of claim 13, wherein each retractable cable fully bypasses the thrust loading on each actuator that is coupled to the same transcowl.

15. The thrust reverser system of claim 13, further comprising:
a plurality of rotatable drums coupled to the support structure, each rotatable drum associated with, and having at least a portion of, one of the retractable cables retractably wound thereon.

16. The thrust reverser system of claim 15, further comprising:
a plurality of springs, each spring coupled to a different one of the rotatable drums and configured to supply a torque thereto, to thereby automatically retract the retractable cables back onto the rotatable drums when the transcowls translate to the stowed position.

17. The thrust reverser system of claim 15, wherein each retractable cable at least partially unwinds from its associated rotatable drum when the transcowls move from the stowed position to the deployed position, and is wound back onto its associated rotatable drum when the transcowls move from the deployed position to the stowed position.

18. The thrust reverser system of claim 17, wherein each retractable drum is configured to exhibit drag when its associated retractable cable is unwinding therefrom.

19. The thrust reverser system of claim 18, further comprising:
a plurality of brakes, each brake associated with, and coupled to, a different of the rotatable drums and configured to at least selectively supply a braking torque to its associated rotatable drum, whereby its associated rotatable drum exhibits drag when its associated retractable cable is unwinding therefrom.

20. The thrust reverser system of claim 19, wherein each brake comprises:
a disc brake that is engaged when the retractable cable is unwinding from the rotatable drum; and
a ratchet that disengages the disc brake when the transcowl moves from the deployed position to the stowed position.
